(19) United States
(12) Patent Application Publication
(10) Pub. No.: US 2015/0130566 A1
(43) Pub. Date: May 14, 2015

(54) MEANS FOR PROVIDING IMPROVED OPERATION PROPERTIES FOR ELECTRICALLY OPERATED CIRCUIT BREAKERS, DISCONNECT SWITCHES, AND CONTACTORS

(71) Applicant: James K. Kinsella, Pleasant View, TN (US)

(72) Inventor: James K. Kinsella, Pleasant View, TN (US)

(21) Appl. No.: 14/080,421

(22) Filed: Nov. 14, 2013

(51) Int. Cl. H01H 3/00

(52) U.S. Cl. CPC H01H 3/00
USPC 335/6

(57) ABSTRACT

Improved circuit breaker operation is achieved by a system that includes a circuit breaker unit and a secondary actuator. The secondary actuator is operable to place the circuit breaker unit into an inoperable position when de-energized and in an operable position when energized. When in the operable position, the circuit breaker can be energized to close its contacts into an ON position. The circuit breaker cannot operate on its own as it cannot be placed into an ON position when energized alone.

### TECHNICAL FIELD

The following disclosure relates in general to electric motor branch circuits and more particularly to means for providing improved operation for electrically operated circuit breakers, disconnect switches, and contactors.

### BACKGROUND

The electric motor is at the core of most industrial processes. They are controlled and protected by a combination of circuit breakers and contactors with a protective relay. The technology has remained unchanged for the last 50 years.

An example of motor control using conventional circuit breakers and contactors can be found in Motor Control Centers (MCCs). These MCCs comprise columns of starters often 6 high in individually isolated units called ‘buckets’. The size of low kW starters is dominated by the conventional circuit breaker used for isolation and short circuit protection. Such conventional circuit breakers are expensive and too slow to provide damage free protection. The construction is complicated by the need for a flange to mount an interlocked operating handle. Conventional circuit breakers also generate heat and their construction complicates electrical interconnects particularly on high kW ratings. The emphasis is on the ability to withstand fault currents rather than minimize damage. Remote operation needs the addition of a secondary motor driven actuator.

Efficient design of electromagnets inherently limit the magnetic gap and with it the amount of contact gap between line and load in the open position.

A straight pull electrically operated circuit breaker may be deficient in magnet pull to accommodate a contact gap sufficient for arc interruption and isolation.

Existing designs of circuit breakers and disconnect switches are mechanical and require add-on motor drives for remote operation.

When contactors are used in safety applications, two contactors connected in series are commonly used for safe isolation reasons.

In addition, current practice is to have expensive and space consuming mechanical mechanisms that operate on a circuit breaker and the enclosure door such as:
1. an UP and DOWN handle located in a flange of the enclosure;
2. a through the door rotary mechanism with a clutch that engages the circuit breaker;
3. an operating mechanism mounted on a fixed plate that directly engages the circuit breaker operating toggle with an aperture in the door being provided that the door opens or closes over;
4. an add-on motor operator is sometimes utilized for remote operation;
5. existing circuit breakers are mechanically operated by means of complex spring, cam, or lever systems that do not have what is termed direct operation, i.e. the direct mechanical connection between the operator and moving contact assembly;
6. due to flexing of the enclosure, circuit breaker contacts that have welded or become mechanically jammed in the closed position can be in the ON position with the external operator forced and locked into the OFF position.
7. door controls are typically mechanical pushbuttons and lights in a custom configuration.

### SUMMARY

Electromagnetic circuit breakers, disconnect switches, and contactors have gaps between line and load contacts that may have insufficient dielectric strength for safe isolation. This invention provides such a means by using a secondary actuator to allow movement of the circuit breaker contact assembly from a ‘cannot operate’ position with inherently larger contact gaps to a ‘can operate’ position when closure is required.

The present disclosure provides solutions to most of the problems mentioned above. Electrical operation enables motor branch circuit protection motors to move into the digital world. This in turn enables a prevention based approach to protection and the flexibility that goes with digital controls, remote operation, and communications.

In addition, further safety measures include a means of providing electrical/electronic/digital safety interlocking between an electrically operated circuit breaker, solenoid operated door latches, and the doors of electrical enclosures.

### BRIEF DESCRIPTION OF THE DRAWINGS

For a more complete understanding of the present disclosure and the advantages thereof, reference is now made to the following description taken in conjunction with the accompanying drawings, wherein like reference numerals represent like parts, in which:

FIG. 1 shows a straight pull electrically operated circuit breaker;

FIG. 2 shows a section AA through the circuit breaker which is in an OFF ‘cannot operate’ position;

FIG. 3 shows the circuit breaker in an OFF ‘can operate’ position;

FIG. 4 shows the actuator in the OFF position;

FIG. 5 shows an actuator in its ON position having moved the circuit breaker armature to the ‘can operate’ position;

FIG. 6 shows the electrically operated circuit breaker in a control system with electrical safety interlocking for electrical enclosures.

### DETAILED DESCRIPTION

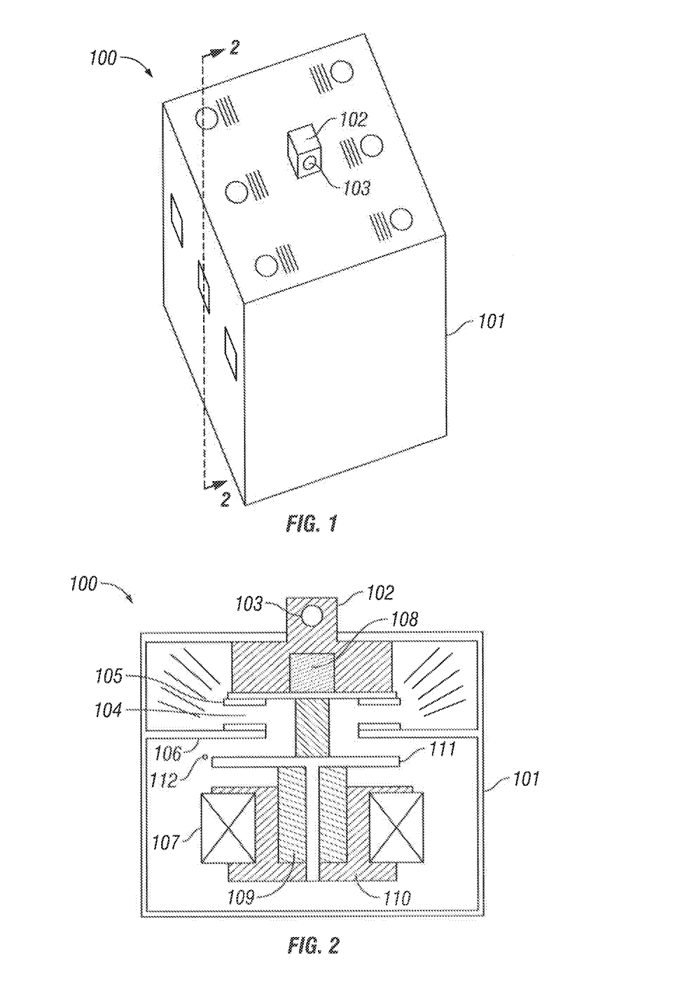

FIG. 1 shows an exterior view of what is termed a straight pull circuit breaker 100. Circuit breaker 100 comprises an enclosure 101. A moving contact molding 102 projects through the top of enclosure 101 with an aperture 103 therethrough Aperture 103 engages a hook 226 of a secondary actuator (to be discussed below). This couples the secondary actuator positively to the straight pull circuit breaker 100 of FIG. 1 so that it acts in unison.

FIG. 2 is an interior view of circuit breaker 100 along section line A-A of FIG. 1. Circuit breaker 100 is shown in an OFF ‘cannot operate’ position. The moving contact molding 102 is pressed against the inside of enclosure 101 allowing a contact gap 104 to be at its maximum. Contact gap 104, between a moving contact 105 and a fixed contact 106, is approximately twice that possible in single magnet designs. If a coil 107 were to be energized, a magnet 110 would have insufficient pull to attract an armature 111 to the closed position and thus the contacts remain safely open. One or more sensors 112, typically an LED, senses when armature 111 moves from its ‘cannot operate’ position. Armature 111 has a non-magnetic coating for quick release when called on to open.

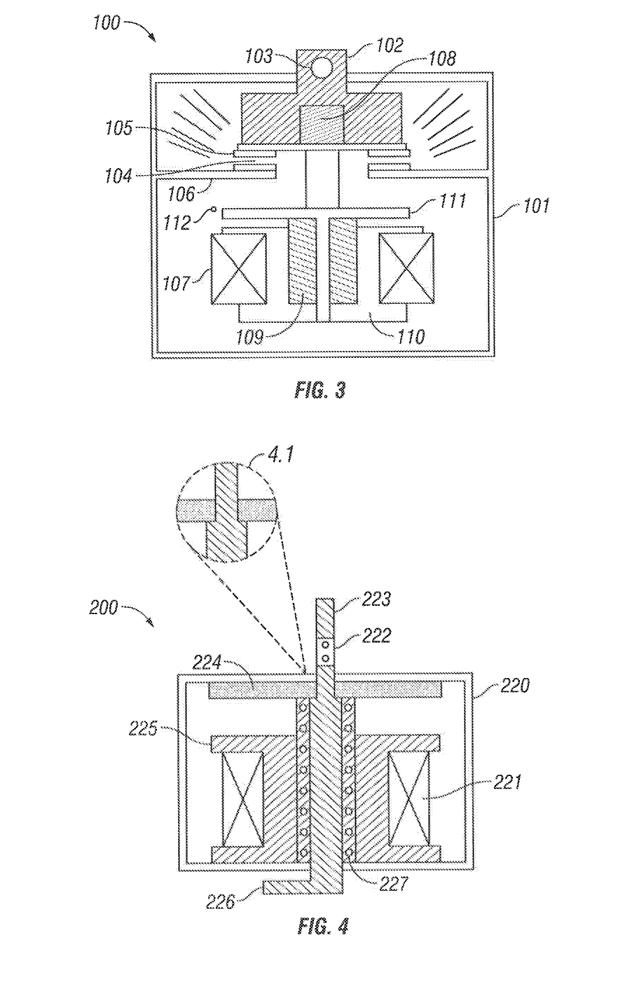

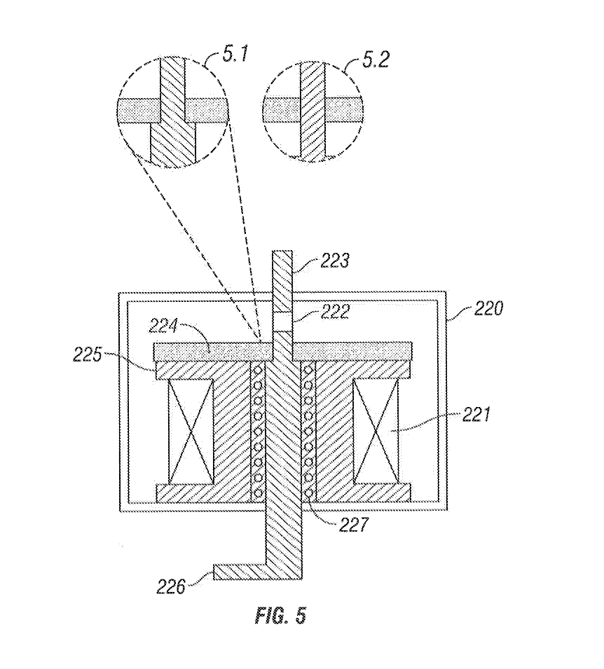

FIG. 3 shows circuit breaker 100 in the ‘can operate’ position. Moving contact molding 102 has been moved away from enclosure 101 to this position by a secondary actuator 200 shown in FIGS. 4 and 5. When coil 107 is energized, magnet 110 attracts armature 111 to the closed position causing contacts 105 and 106 to close. A spring 108 is used to apply pressure to contacts 105 and 106 in the closed position. A spring 109 returns the moving contact molding 102 to the open position when magnet 110 is de-energized.

FIG. 4 shows a secondary actuator 200 in the OFF position. Secondary actuator 200 includes an enclosure 220 and an actuator rod 223 with an aperture 222 therethrough that may provide a means for attaching a mechanical lock for an additional level of safety. Actuator rod 223 also has the means of locking into the moving contact molding 102 to ensure a positive and direct mechanical connection to actuator 111 of the circuit breaker 100 by use of a hook 226 through aperture 103 or by any other equivalent means. An operating coil 221 causes a magnet 225 to attract an armature 224 to the closed position as shown in FIG. 5. Inset 4.1 shows a shoulder that allows actuator rod 223 to push armature 111 into the ‘can operate’ position and when the armature 111 of circuit breaker 100 moves, actuator rod 223 is allowed to move with it. Armature 224 has a non-magnetic coating, e.g. zinc plating, to give a non-magnetic gap so as to facilitate quick release of armature 224 when magnet 225 is de-energized. A spring 227 returns armature 224 to the open OFF position.

FIG. 5 shows secondary actuator 200 in its energized position which moves armature 111 to the ‘can operate’ position. Inset 4.1 from FIG. 4 and Inset 5.1 in FIG. 5 show a shoulder of actuator rod 223 engaged with armature 224. Inset 5.2 shows how actuator rod 223 works with armature 224. The shoulder of actuator rod 223 moves away from armature 224 when the circuit breaker 100 is closing after armature 224 and actuator rod 223 have placed armature 111 into the ‘can operate’ position.

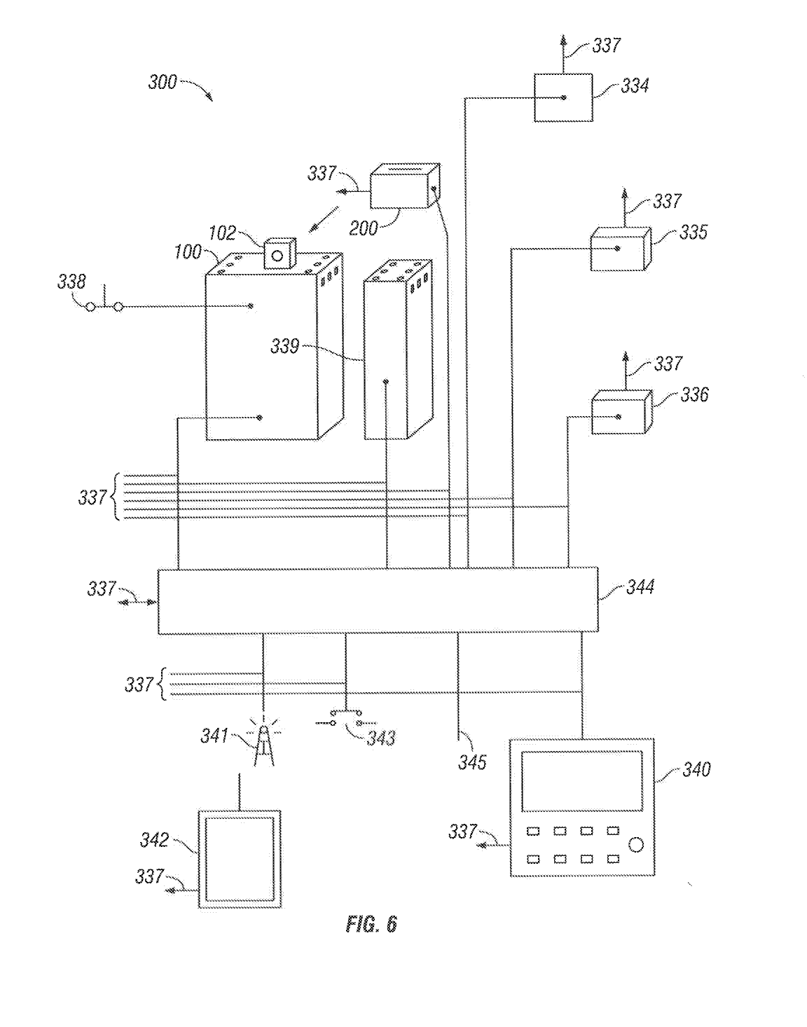

FIG. 6 shows a system 300 for electrical interlocking of electrical enclosures having a logic controller 344 with low voltage connections 337, typically 24 volts DC, supplying power to all elements and connecting to circuit breaker 100 of FIGS. 1, 2, and 3 and secondary actuator 200 of FIGS. 4 and 5. Door locking actuators 334, 335, and 336 have built in sensors for detecting door position. A local display 340 is typically hardwired with other necessary local interfaces. A remote user interface 342 and wireless networking connection 341 can be connected by communication buses or through the air media for remote communications. There may also be a direct connection 345 to logic controller 344. Conventional local pushbutton control 343 and emergency stop 338 are also provided for. Secondary actuator 200 as detailed in FIGS. 4 and 5 has means to securely mate with circuit breaker 100 as detailed in FIGS. 1, 2, and 3 with hook 226 from FIGS. 4 and 5 being engaged with aperture 103 in FIGS. 1, 2, and 3. A contactor 339 is used for motor switching.

A first key element is the use of a pulse width modulated (PWM) DC magnet to replace the mechanical spring/lever system in conventional circuit breakers. A second key element is secondary actuator 200 that facilitates a large contact gap 104 in circuit breaker 100 and provides the means to move armature 111 of circuit breaker 100 from a position where it cannot close to a position whereby it can close.

In addition, conventional mechanical means of providing safe operation and maintenance of electrical enclosures are replaced by electrical/electronic/digital means to improve safety. Thus, one major advantage of this new approach is to provide safety interlocking of electrical enclosures enabled by the electrically operated circuit breaker, whose operation is by means of a straight pull electromagnet rather than a mechanical mechanism. A second major advantage is the secondary actuator 200 whose actuating rod 223 provides a direct mechanical connection between the optional external locking means and the moving contact assembly of the circuit breaker 100. Thus, if a lock is attached to aperture 222 at the external end of actuator rod 223, circuit breaker 100 is positively locked into an OFF position. The significance of this is that there is no interposing mechanism between the moving contact assembly and the means of positively locking in the OFF position.

Electromagnetics may not have sufficient pull to allow for safe circuit breaker contact gaps for isolation or fault interruption. Thus, secondary actuator 200 provides the additional ability to move armature 111 of circuit breaker 100 to an appropriate position. Once in the energized position, actuator rod 223 then moves with armature 111 of circuit breaker 100 when circuit breaker 100 moves to its closed ON position.

The next safety level is provided by the interaction between circuit breaker 100 and secondary actuator 200 and the design of circuit breaker 100. When in its OFF position, circuit breaker 100 cannot by itself completely close as the size of magnet 110, return spring 109, and contact spring 108 do not permit the entire elimination of contact gap 104. Circuit breaker 100 can only operate when actuator rod 223 moves armature 111 of circuit breaker 100 to its ‘can operate’ position. When sensor 112 detects that armature 111 of circuit breaker 100 has moved from its ‘can operate’ position, secondary actuator 200 is de-energized and returns to its OFF position. Circuit breaker 100 coil control is precisely controlled such that it can hold armature 111 in a stalled position. Thus, when secondary actuator 200 starts to return to its OFF position, armature 111 of circuit breaker 100 momentarily stalls prior to increasing coil current to fully close circuit breaker 100. This allows the use of both return spring 109 and contact spring 108 with high forces that enable magnet 110 to release very quickly for fault current interruption.

Armature 224 of secondary actuator 200 is given a non-magnetic coating to allow a fast opening when de-energized. This is important as secondary actuator 200 must not impede any opening of circuit breaker 100 to its fully open OFF position.

In the OFF position, return spring 109 of circuit breaker 100 moves the contact assembly to the fully open position. Contact gap 104 is then able to be 3 to 5 mm greater as compared to an assembly without secondary actuator 200. In the OFF position, magnet 110 of circuit breaker 100 is unable to close armature 111, placing circuit breaker 100 in the ‘cannot operate’ position.

Thus, when circuit breaker 100 is required to close, magnet 225 of secondary actuator 200 acts to move armature 111 of circuit breaker 100 to a ‘can operate’ position. With contact gap 104 now shortened, circuit breaker 100 is then able to operate when its control coil is energized. Energizing coil 107 of circuit breaker 100 has a current source, pulse width modulated (PWM), control that is able to move armature 111 1 mm and then stall momentarily. When sensor 112 detects movement of armature 111, secondary magnet 225 is de-energized and armature 111 moves rapidly to closure. This is important because secondary actuator 200 must be in the OFF position, so when circuit breaker 100 is called on to interrupt a fault current, it will have sufficient contact gap 104 to permit the arc to be extinguished.

The requirements for contactors and disconnect switches, while different in function, share the same principle design benefits.

The use of secondary actuator 200 allows return spring 109 to be profiled so as to permit high contact pressures and initial moving contact return springs so as to give maximum contact opening force. Lower rate springs 108 and 109 return the moving contact assembly to the fully OFF position. This is critical in ensuring that circuit breaker 100 can quickly respond to high fault currents and to keep the force needed by secondary actuator 200 to remain low.

Both single pole and multiple pole arrangements are possible. It may be advantageous for the coils 107 and 221 of circuit breaker 100 and secondary actuator 200 to have control circuitry that reverses coil current for the fastest possible opening.

Being digital, all major components are given unique product data for displaying through the controller and via the communication network.

Circuit breaker 100 provides certain safety measures. Two actions are needed before the device can be operated—first, energizing the secondary magnet coil 221 of secondary actuator 200 and second, followed by energizing the operating coil 107 of circuit breaker 100. Supply failure will result in the device opening to its fully open ‘cannot operate’ position. Contact gap 104 in circuit breaker 100 and dielectric strength in the open position allows for safe maintenance of electrical equipment and its load. Secondary actuator 200 can itself be integrated with circuit breaker 100 into an electrically based enclosure safety interlocking system with additional levels of safety. Safety applications with contactors can use a single device instead of two.

This system provides multiple levels of safety interlocking as follows:
1. a conventional door handle with locking means;
2. password to the local user interface 342;
3. the locking of electrical enclosure doors by means of electrical door latches;
4. monitoring of door position by sensors inside the door latches;
5 a first step of energizing secondary actuator 200 for moving armature 111 of circuit breaker 100 to the ‘can operate’ position as discussed above;
6. provides for fitting of a mechanical lock to actuator rod 223 of the circuit breaker/secondary actuator assembly to provide means of locking circuit breaker 100 in the positive OFF position.
7. the door locks, circuit breaker 100, and secondary actuator 200 must be energized before power is applied to the motor starter.
8. in the event of power failure, circuit breaker 100 is returned to its fully OFF ‘cannot operate’ position.
9. when the circuit breaker is in the fully OFF position its contact gap provides a very high dielectric strength with elevated levels of creepage and clearance.

One or more electrically operated door latches, 334, 335, and 336 of FIG. 6, are used to lock the enclosure door. The sensors and door locking means are arranged to allow the safe opening and closing of the enclosure door. They contain sensors to monitor the enclosure door position. The door latches are provided with a means to permit authorized manual opening to manually override for maintenance.

A controller, whose function may reside in an associated product, provides for a means of logically coordinating the safe operation of the circuit breaker, secondary actuator, motor switching contactor, and the associated safety interlocking. It also contains the 24 volt DC power supply and PWM control for both circuit breaker and motor starting contactor. The electrical controls operate on 24 volt DC to facilitate safe maintenance. The user interface has an access code for controlling both access and controller functions.

The local display is configurable, dispensing with the need for custom door controls and indicator lights.

The circuit breaker/secondary actuator assembly discussed herein provides a solution to the problems encountered by conventional circuit breakers. Improved circuit breaker operation and enhanced safety measures can be achieved using the techniques provided above.

It may be advantageous for the secondary actuator function to be integrated into a single assembly with the straight pull circuit breaker.

Although the present disclosure has been described in detail with reference to particular embodiments, it should be understood that various other changes, substitutions, variations, alterations, and modifications may be ascertained by those skilled in the art and it is intended that the present disclosure encompass all such changes, substitutions, variations, alterations, and modifications as falling within the spirit and scope of the appended claims. Moreover, the present disclosure is not intended to be limited in any way by any statement in the specification that is not otherwise reflected in the appended claims.

What is claimed is:

1. A circuit breaker assembly, comprising:
a circuit breaker unit;
a secondary actuator operable to place the circuit breaker unit into an operable position when energized and maintain the circuit breaker in an inoperable position when de-energized.

2. The assembly of claim 1, wherein the secondary actuator includes an actuator rod and the circuit breaker unit includes a first armature, the actuator rod being coupled to the first armature.

3. The assembly of claim 2, wherein the secondary actuator includes a second armature to move the actuator rod towards the circuit breaker unit when energized, causing the actuator rod to move the first armature into the operable position.

4. The assembly of claim 3, wherein the actuator rod is operable to move independently of the second armature when the circuit breaker is energized.

5. The assembly of claim 2, wherein the circuit breaker unit holds the first armature in a momentary stall position prior to energizing and causing the first armature to fully close.

6. The assembly of claim 1, wherein the circuit breaker unit is inoperable on its own.

7. The assembly of claim 1, wherein the circuit breaker unit has a contact gap that cannot be closed by the circuit breaker unit alone.

8. The assembly of claim 1, wherein the circuit breaker unit includes a sensor to detect that the circuit breaker unit is in an operable position.

9. The assembly of claim 1, wherein the circuit breaker includes a sensor to detect that the circuit breaker unit has been energized from its operable position.

10. The assembly of claim 9, wherein the sensor is operable to de-energize the secondary actuator.

11. The assembly of claim 1, wherein the circuit breaker unit and the secondary actuator are housed in a common enclosure.

12. A method of controlling a circuit breaker, comprising:
setting a distance between contacts in a circuit breaker such that the circuit breaker cannot independently close the contacts;
energizing a secondary actuator to place the circuit breaker into an operable position.

13. The method of claim 12, further comprising:
energizing the circuit breaker to close the contacts once the circuit breaker is placed into the operable position.

14. The method of claim 13, further comprising:
holding a first armature of the circuit breaker in a momentary stall position prior to energizing and causing the contacts to fully close.

15. The method of claim 14, further comprising:
de-energizing the secondary actuator.

16. The method of claim 12, wherein the secondary actuator when energized moves a second armature and an actuator rod towards the circuit breaker, the actuator rod moving a first armature of the circuit breaker into the operable position.

17. The method of claim 16, further comprising:
energizing the circuit breaker to move the first armature and close the contacts, the actuator rod moving with the first armature independently of the second armature.

18. The method of claim 17, further comprising:
detecting when the first armature is moving to close the contacts;

19. The method of claim 18, further comprising:
de-energizing the secondary actuator in response to the detection.

20. The method of claim 12, further comprising:
detecting when the circuit breaker is placed in the operable position.
